(19) United States
(12) Patent Application Publication
(10) Pub. No.: US 2017/0105237 A1
(43) Pub. Date: Apr. 13, 2017

(54) METHODS AND APPARATUSES FOR NETWORK CONNECTION

(71) Applicant: Xiaomi Inc., Beijing (CN)

(72) Inventors: Zhuang Qian, Beijing (CN); Yong Chen, Beijing (CN); Xibei Zhang, Beijing (CN)

(73) Assignee: Xiaomi Inc., Beijing (CN)

(21) Appl. No.: 15/266,322

(22) Filed: Sep. 15, 2016

(30) Foreign Application Priority Data
Oct. 12, 2015 (CN) 201510660883.3

(51) Int. Cl. H04W 76/02; H04L 29/12; H04W 12/06; H04L 29/08; H04B 17/318

(52) U.S. Cl. CPC H04W 76/021; H04L 67/303; H04B 17/318; H04W 12/06; H04L 61/6081; H04W 84/12

(57) ABSTRACT

The present disclosure relates to a method and apparatus for network connection. The method includes: receiving a first network information of a network connection device to which a terminal is currently connected; determining whether the first network information matches pre-stored second network information wherein the pre-stored second network information corresponds to at least one network connection device within a preset range of a preset network connection device corresponding to the terminal; and if the first network information matches the second network information; determining whether the first network information matches the second network information; and sending to the terminal a notification information for notifying the terminal that the terminal can be connected to the preset network connection device upon determining that the first network information matches the second network information.

### PRIORITY STATEMENT

This application is based upon and claims priority to Chinese Patent Application No. 201510660883.3, filed Oct. 12, 2015, the entire contents of which are incorporated herein by reference.

### TECHNICAL FIELD

The present disclosure generally relates to the Internet technical field, and more particularly, to methods and apparatuses for network connection.

### BACKGROUND

One of the functions of smart routers is that a user can manage and access data in the routers by application programs anywhere and anytime. However, due to the limitation of upload band width of external networks, the speeds for accessing router data via internal networks and external networks are totally different, usually by one to two orders of magnitude. The router is managed by its user (hereinafter the “user's router”). But with the proliferation of wireless network technology, often times the user may find that in addition to the user's router there are also other external networks such as Wi-Fi hotspots surrounding him/her. As a result, even if the user is in the proximity of the user's router, the user's mobile device may not directly connect to the user's router. Rather, the user's mobile device may access the data stored in the user's router via the external networks, and the accessing speed is reduced or experience of other users may be influenced. With respect to this problem, the user may search whether the user's router is in the proximity by application programs on the mobile device; if the user's router is in the proximity of the user, the user may select to re-access the user's router and thereby to access the router data via the internal networks. However, for some systems such as iOS system, the installed application programs have no permission to search the nearby Wi-Fi and thus switching to the internal networks cannot be realized by this approach.

### SUMMARY

Embodiments of the present disclosure provide methods and apparatuses for network connection. The technical solutions are as follows.

According to a first aspect of embodiments of the present disclosure, there is provided a method for network connection, applied at a network side and including:

receiving first network information of a network connection device which a terminal is currently connected to;

determining whether the first network information matches pre-stored second network information which is network information of a network connection device within a preset range of a preset network connection device corresponding to the terminal; and

if the first network information matches the second network information, sending the terminal notification information for notifying the terminal that the terminal can be connected to the preset network connection device currently.

According to a second aspect of embodiments of the present disclosure, there is provided a method for network connection, applied in a terminal and including:

sending a network side first network information of a network connection device which the terminal is currently connected to;

if receiving first notification information sent from the network side, obtaining third network information of a preset network connection device corresponding to the terminal, wherein the first notification information is configured to notify the terminal that the terminal can be connected to the preset network connection device, and the third network information includes at least one of a network name and a network password of the preset network connection device; and

accessing the preset network connection device according to the third network information.

According to a third aspect of embodiments of the present disclosure, there is provided a method for network connection, applied in a preset network connection device and including:

obtaining network information of network connection devices within a preset range; and

sending the network information to a network side.

According to a fourth aspect of embodiments of the present disclosure, there is provided an apparatus for network connection, applied at a network side and including:

a processor; and

a memory for storing instructions executable by the processor;

wherein the processor is configured to:

receive first network information of a network connection device which a terminal is currently connected to;

determine whether the first network information matches pre-stored second network information which is network information of a network connection device within a preset range of a preset network connection device corresponding to the terminal; and

if the first network information matches the second network information, send the terminal notification information for notifying the terminal that the terminal can be connected to the preset network connection device currently.

According to a fifth aspect of embodiments of the present disclosure, there is provided an apparatus for network connection, applied in a terminal and including:

a processor; and

a memory for storing instructions executable by the processor;

wherein the processor is configured to:

send a network side first network information of a network connection device which the terminal is currently connected to;

if receive first notification information sent from the network side, obtain third network information of a preset network connection device corresponding to the terminal, wherein the first notification information is configured to notify the terminal that the terminal can be connected to the preset network connection device, and the third network information includes at least one of a network name and a network password of the preset network connection device; and

access the preset network connection device according to the third network information.

According to a sixth aspect of embodiments of the present disclosure, there is provided an apparatus for network connection, applied in a preset network connection device and including:

a processor; and

a memory for storing instructions executable by the processor;

wherein the processor is configured to:

obtain network information of network connection devices within a preset range; and

send the network information to a network side.

According to a seventh aspect of embodiments of the present disclosure, there is provided a non-transitory computer-readable storage medium having stored therein instructions that, when executed by a processor of a network side device, causes the network side device to perform a method for network connection, the method including:

receiving first network information of a network connection device which a terminal is currently connected to;

determining whether the first network information matches pre-stored second network information which is network information of a network connection device within a preset range of a preset network connection device corresponding to the terminal; and

if the first network information matches the second network information, sending the terminal notification information for notifying the terminal that the terminal can be connected to the preset network connection device currently.

According to an eighth aspect of embodiments of the present disclosure, there is provided a non-transitory computer-readable storage medium having stored therein instructions that, when executed by a processor of a terminal, causes the terminal to perform a method for network connection, the method including:

sending a network side first network information of a network connection device which the terminal is currently connected to;

if receiving first notification information sent from the network side, obtaining third network information of a preset network connection device corresponding to the terminal, wherein the first notification information is configured to notify the terminal that the terminal can be connected to the preset network connection device, and the third network information comprises at least one of a network name and a network password of the preset network connection device; and

accessing the preset network connection device according to the third network information.

According to a ninth aspect of embodiments of the present disclosure, there is provided a non-transitory computer-readable storage medium having stored therein instructions that, when executed by a processor of a preset network connection device, causes the preset network connection device to perform a method for network connection, the method including:

obtaining network information of network connection devices within a preset range; and

sending the network information to a network side.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for network connection according to an exemplary embodiment;

FIG. 2 is a flowchart showing step S12 in the method for network connection of FIG. 1 according to an exemplary embodiment;

FIG. 3 is a flowchart showing step S122 in the method for network connection of FIG. 2 according to an exemplary embodiment;

FIG. 4 is a flowchart showing step S33 in the method for network connection of FIG. 3 according to an exemplary embodiment;

FIG. 5 is a flowchart showing step S122 in the method for network connection of FIG. 2 according to an exemplary embodiment;

FIG. 6 is a flowchart showing another method for network connection according to an exemplary embodiment;

FIG. 7 is a flowchart showing another method for network connection according to an exemplary embodiment;

FIG. 8 is a flowchart showing another method for network connection according to an exemplary embodiment;

FIG. 9 is a flowchart showing a method for network connection according to a specific implementation;

FIG. 10 is a diagram showing an interface for displaying notification information on a terminal in a method for network connection according to a specific embodiment;

FIG. 11 is a flowchart showing a method for network connection according to a specific embodiment;

FIG. 12 is a block diagram showing an apparatus for network connection according to an exemplary embodiment;

FIG. 13 is a block diagram showing an apparatus for network connection according to an exemplary embodiment;

FIG. 14 is a block diagram showing a determination module in the apparatus for network connection according to an exemplary embodiment;

FIG. 15 is a block diagram showing a determination module in the apparatus for network connection according to an exemplary embodiment;

FIG. 16 is a block diagram showing a notification module in the apparatus for network connection according to an exemplary embodiment;

FIG. 17 is a block diagram showing an apparatus for network connection according to an exemplary embodiment;

FIG. 18 is a block diagram showing an apparatus for network connection according to an exemplary embodiment;

FIG. 19 is a block diagram showing a second obtaining module in the apparatus for network connection according to an exemplary embodiment;

FIG. 20 is a block diagram showing a second obtaining module in the apparatus for network connection according to an exemplary embodiment;

FIG. 21 is a block diagram showing an apparatus for network connection according to an exemplary embodiment;

FIG. 22 is a block diagram showing a third obtaining module in the apparatus for network connection according to an exemplary embodiment;

FIG. 23 is a block diagram showing a third sending module in the apparatus for network connection according to an exemplary embodiment;

FIG. 24 is a block diagram showing a third sending module in the apparatus for network connection according to an exemplary embodiment;

FIG. 25 is a block diagram showing a third sending module in the apparatus for network connection according to an exemplary embodiment;

FIG. 26 is a block diagram showing an apparatus for network connection according to an exemplary embodiment;

FIG. 27 is a block diagram showing an apparatus for network connection according to an exemplary embodiment; and

FIG. 28 illustrates a network environment for devices and methods of the present disclosure.

### DETAILED DESCRIPTION

Reference will now be made in detail to exemplary embodiments, examples of which are illustrated in the accompanying drawings. When the following description refers to the accompanying drawings, the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

FIG. 28 illustrates a network environment for devices and methods of the present disclosure. The technical solutions provided by embodiments of the present disclosure involve three parties in the network environment, i.e., a network side, a preset network connection device and a terminal. The network side 2810 may be a computer server (e.g. a cloud server) including a database 2812. The preset network connection device may be an electronic device configured to connect to two or more data lines between a plurality of networks to forward data packets between the plurality of networks. The data lines may be of any kind, including various wireline and wireless connections. For example, the network connection device may be a router 2806, a Wi-Fi hotspot device 2802, or other types of devices that connects to the network 2820 and provides network connection to the terminal 2804. The terminal 2804 may be a computer device such as a smart phone, a laptop, a tablet computer etc. The terminal 2804 may be able to directly connect to the network 2820. But when the terminal 2804 is within a predetermined range of any one of the network connection devices 2802, 2806, the terminal 2804 may connect to the network connection device 2802, 2806, and through which connect to the network 2820. The terminal 2804 may have certain preference to different network connection devices 2802, 2806. For example, the terminal 2804 may automatically select one of the network connection devices 2802, 2806 with stronger signal. Alternatively, the terminal 2804 may also establish certain preset relationship with a network connection device 2802, 2806.

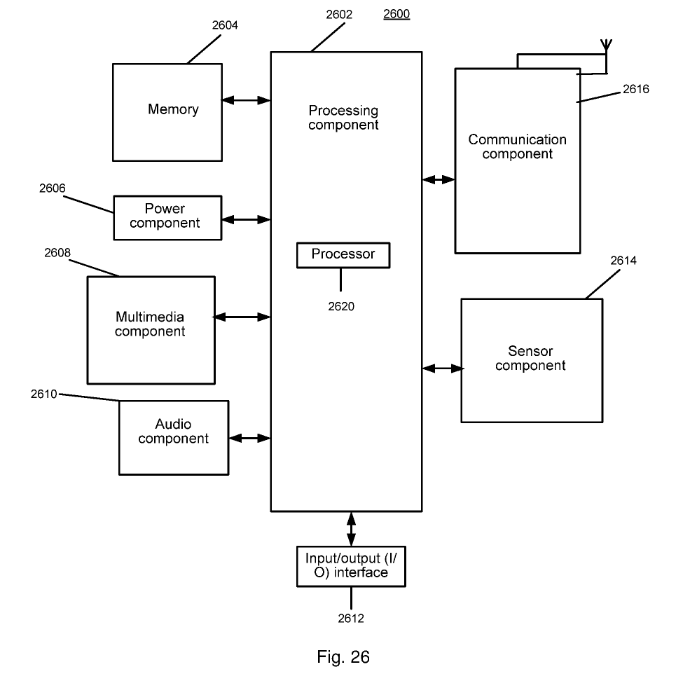

FIG. 26 is a block diagram of an apparatus 2600 for network connection according to an exemplary embodiment. The apparatus may serve as the terminal 2804 in the network environment 2800. For example, the apparatus 2600 may be a mobile phone, a computer, a digital broadcast terminal, a messaging device, a gaming console, a tablet, a medical device, exercise equipment, a personal digital assistant, and the like.

The apparatus 2600 may include one or more of the following components: a processing component 2602, a memory 2604, a power component 2606, a multimedia component 2608, an audio component 2610, an input/output (I/O) interface 2612, a sensor component 2614, and a communication component 2616.

The processing component 2602 typically controls overall operations of the apparatus 2600, such as the operations associated with display, telephone calls, data communications, camera operations, and recording operations of the apparatus 2600. The processing component 2602 may include one or more processors 2620 to execute instructions to perform all or part of the steps in the above described methods. Moreover, the processing component 2602 may include one or more modules which facilitate the interaction between the processing component 2602 and other components. For instance, the processing component 2602 may include a multimedia module to facilitate the interaction between the multimedia component 2608 and the processing component 2602.

The memory 2604 is configured to store various types of data to support the operation of the apparatus 2600. Examples of such data include instructions for any applications or methods operated on the apparatus 2600, contact data, phonebook data, messages, pictures, video, etc. The memory 2604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2606 provides power to various components of the apparatus 2600. The power component 2606 may include a power management system, one or more power sources, and any other components associated with the generation, management, and distribution of power in the apparatus 2600.

The multimedia component 2608 includes a screen providing an output interface between the apparatus 2600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2608 includes a front camera and/or a rear camera. The front camera and the rear camera may receive an external multimedia datum while the apparatus 2600 is in an operation mode, such as a photographing mode or a video mode. Each of the front camera and the rear camera may be a fixed optical lens system or have focus and optical zoom capability.

The audio component 2610 is configured to output and/or input audio signals. For example, the audio component 2610 includes a microphone (“MIC”) configured to receive an external audio signal when the apparatus 2600 is in an operation mode, such as a call mode, a recording mode, and a voice recognition mode. The received audio signal may be further stored in the memory 2604 or transmitted via the communication component 2616. In some embodiments, the audio component 2610 further includes a speaker to output audio signals.

The I/O interface 2612 provides an interface between the processing component 2602 and peripheral interface modules, such as a keyboard, a click wheel, buttons, and the like. The buttons may include, but are not limited to, a home button, a volume button, a starting button, and a locking button.

The sensor component 2614 includes one or more sensors to provide status assessments of various aspects of the apparatus 2600. For instance, the sensor component 2614 may detect an open/closed status of the apparatus 2600, relative positioning of components, e.g., the display and the keypad, of the apparatus 2600, a change in position of the apparatus 2600 or a component of the apparatus 2600, a presence or absence of user contact with the apparatus 2600, an orientation or an acceleration/deceleration of the apparatus 2600, and a change in temperature of the apparatus 2600. The sensor component 2614 may include a proximity sensor configured to detect the presence of nearby objects without any physical contact. The sensor component 2614 may also include a light sensor, such as a CMOS or CCD image sensor, for use in imaging applications. In some embodiments, the sensor component 2614 may also include an accelerometer sensor, a gyroscope sensor, a magnetic sensor, a pressure sensor, or a temperature sensor.

The communication component 2616 is configured to facilitate communication, wired or wirelessly, between the apparatus 2600 and other devices. The apparatus 2600 can access a wireless network based on a communication standard, such as Wi-Fi, 2G, 3G, LTE, or 4G cellular standard, or a combination thereof. In one exemplary embodiment, the communication component 2616 receives a broadcast signal or broadcast associated information from an external broadcast management system via a broadcast channel. In one exemplary embodiment, the communication component 2616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 2600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 804, executable by the processor 2620 in the apparatus 2600, for performing the above-described methods. For example, the non-transitory computer-readable storage medium may be a ROM, a RAM, a CD-ROM, a magnetic tape, a floppy disc, an optical data storage device, and the like.

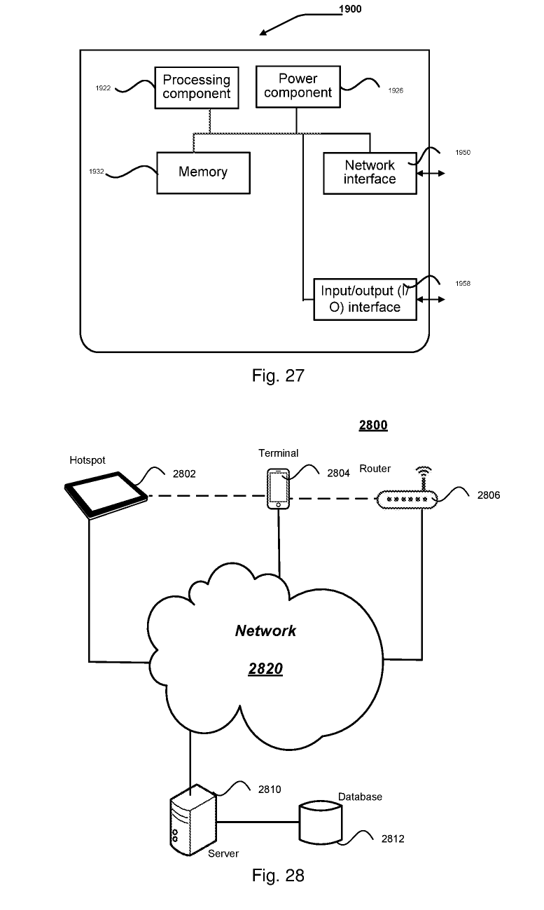

FIG. 27 is a block diagram showing an apparatus for network connection according to an exemplary embodiment. For example, the apparatus 1900 may serve as the server 2810 in the network environment 2800. The apparatus 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Further, the processing component 1922 is configured to execute the instructions to perform the above described method.

The apparatus 1900 may also include a power component 1926 configured to perform power management of the apparatus 1900, wired or wireless network interface(s) 1950 configured to connect the apparatus 1900 to a network, and an input/output (I/O) interface 1958. The apparatus 1900 may operate based on an operating system stored in the memory 1932, such as Windows Server™, Mac OS X™, Unix™, Linux™, FreeBSD™, or the like.

Referring back to FIG. 28. The network side 2810 is configured to receive network information sent from the terminal 2804 and network information sent from the preset network connection device 2802, 2806, and determine whether the terminal 2804 is in the proximity of the preset network connection device corresponding to the terminal according to the network information sent from the terminal and network information sent from the preset network connection device. The preset network connection device is configured to detect network information of nearby network connection devices, and send the detected network information to the network side. The terminal is configured to send the network information of the network connection device to which the terminal is currently connected to the network side, and access the preset network connection device corresponding to the terminal after receiving notification information sent from the network side. By the technical solutions of the present disclosure, when the terminal is in the proximity of the preset network connection device corresponding to the terminal, the terminal can accurately access the preset network connection device. Thus, the present disclosure can avoid the situation where the terminal accesses the data in the preset network connection device corresponding to the terminal via external networks, and thereby increases the network communication speed of the terminal. Depending on the parties which perform the methods, three sets of methods for network connection are provided in embodiments of the present disclosure as below.

Network Side

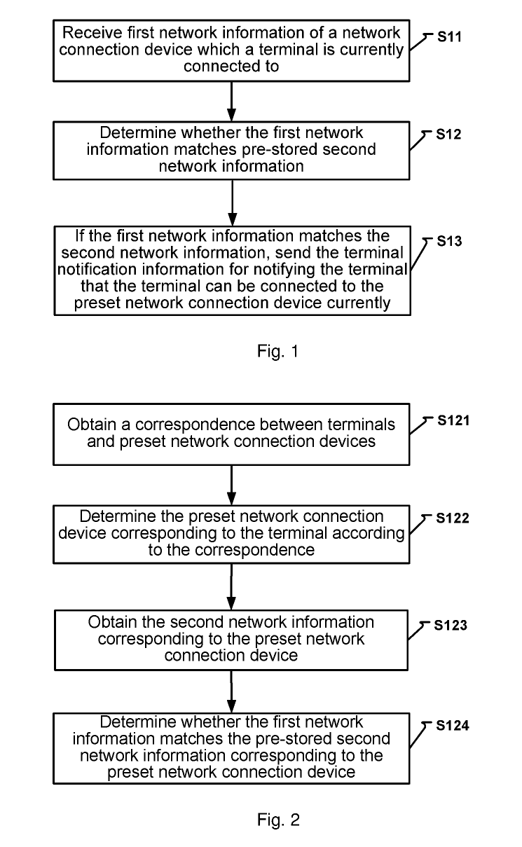

FIG. 1 is a flowchart showing a method for network connection according to an exemplary embodiment. As shown in FIG. 1, the method for network connection may be implemented at a network side, such as a computer server 1900. For example, the method may be implemented as a set of instructions and stored in a non-transitory storage medium of the computer server 1900. The processor of the computer server 1900 may communicate with the storage medium and execute the set of instruction. The method may include the following steps S11-S13.

In step S11, receiving, from a terminal in communication with the server, first network information of a network connection device to which the terminal is currently connected to and used to communicate with the server.]

In step S12, determining whether the first network information matches pre-stored second network information for the terminal. The pre-stored second network information contains network information of at least a network connection device within a preset range (spatial range, or signal range, for example) of a preset network connection device corresponding to the terminal. When the second information contains network information of multiple network connection devices within the preset range, there is a “match” if the information in the first network information matches the network information of one of the multiple network connection devices within the second network information. The second network information is referred to interchangeably as pre-stored second network information.

In this step, the pre-stored second network information is sent by the preset network connection device to the network side in advance. The network side may receive the second network information sent from the preset network connection device by the following approaches: periodically obtaining the second network information sent from the preset network connection device; and updating the second network information. By periodically updating the second network information, the network side can, according to the second network information, more accurately determine whether the terminal is in proximity of the preset network connection device corresponding to the terminal. In a database at the network side, each preset network connection device of a terminal corresponds to second network information sent by each corresponding preset network connection device for a terminal.

In step S13, if the first network information matches the second network information, sending notification information to the terminal. The notification information is configured to notify the terminal that the terminal is in the range of and can be connected to its preset network connection device currently.

In an embodiment, as shown in FIG. 2, step S12 may be implemented as the following steps S121-S124.

In step S121, obtaining a correspondence between the terminal and its preset network connection device. Although the following embodiment that there is one corresponding preset network connection device for the terminal, the terminal may corresponds more than one preset network connection devices. The principle described below may be applied to each preset network connection device corresponding to the terminal for step S121. The term “preset network connection device” thus may be understood as both a singular and plural forms.

In step 122, according to the above correspondence, determining the preset network connection device corresponding to the terminal.

In step 123, obtaining the second network information corresponding to the preset network connection device.

In step 124, determining whether the first network information matches the pre-stored second network information corresponding to the preset network connection device.

In the embodiment, the correspondence between terminals and their preset network connection devices may be a correspondence between identities of terminals and network names of preset network connection devices, or may be a correspondence between identities of terminals and network addresses of preset network connection devices. The implementation of step S122 will be explained below using the two exemplary correspondences.

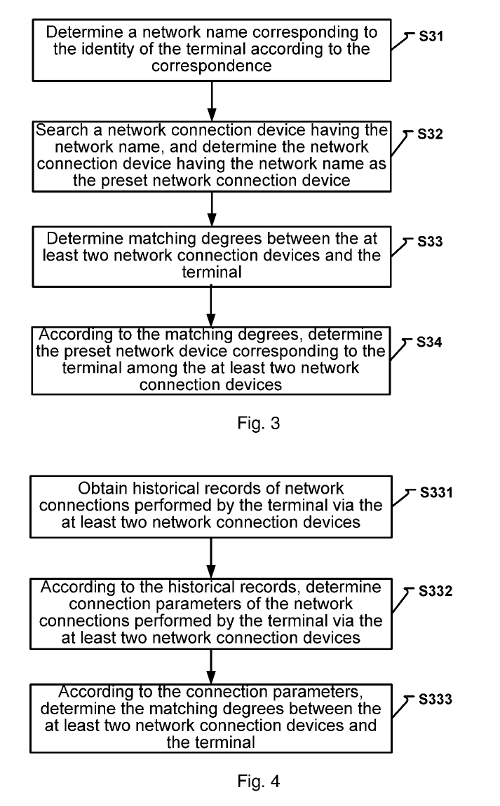

In an embodiment, when the correspondence between terminals and preset network connection devices is the correspondence between identities of terminals and network names of preset network connection devices, step S122 may be implemented as steps S31-S32 as shown in FIG. 3.

In step S31, according to the correspondence, determining a network name corresponding to an identity of the terminal.

In the step, the network side additionally receives from the terminal the identity of the terminal, and thus the network name of the preset network connection device corresponding to the terminal identity can be determined according to the correspondence between identities of terminals and network names of preset network devices. Because a plurality of network connection devices may have the same network name, it is possible that the computer server may find more than one network connection device according to the correspondence between identities of terminals and network names of preset network connection devices. For example, the network name of the preset network connection device corresponding to the terminal is “TP_LINK”, and in the database at the network side, other network connection devices that are not preset network connection devices of the terminal may also have the network name “TP_LINK”.

In step S32, searching a network connection device having the network name (herein referred to as the target network name) corresponding to the terminal identity, and determining the network connection device having the target network name as the preset network connection device.

Specifically in this step, when at least two candidate network connection devices having the target network name are found, the computer server may further accurately determine the preset network connection device corresponding to the terminal among the plurality of candidate network connection devices. At this time, step S122 may further include the steps S33-S34 as shown in FIG. 3.

In step S33, determining matching degrees between the at least two candidate network connection devices and the terminal.

Step S33 may be implemented as steps S331-S333 as shown in FIG. 4.

In step S331, obtaining historical records of network connections performed by the terminal via the at least two candidate network connection devices.

In step S332, according to the historical records, determining connection parameters of the network connections performed by the terminal via the at least two candidate network connection devices. The connection parameters include any one or more of number of times of connection, connection frequency, and connection speed.

In step S333, according to the connection parameters, determining a matching degrees between each of the at least two candidate network connection devices and the terminal based on the corresponding connection parameters. For example, the matching degree may be proportional to the number of times of connection, connection frequency, and connection speed. Thus a greater number of times of connection may indicate a higher matching degree between the candidate network connection device and the terminal. The matching degree may reflect how “close” it is between the candidate network connection device and the terminal.

Back to FIG. 3 and in step S34, according to the matching degrees, determining the preset network device corresponding to the terminal among the at least two candidate network connection devices.

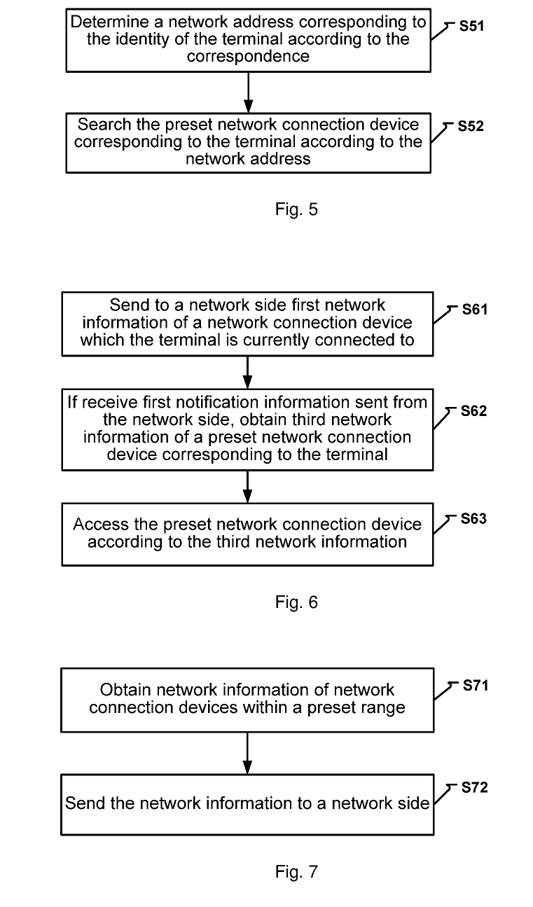

In another embodiment, when the correspondence between terminals and preset network connection devices is a correspondence between identities of terminals and network addresses of preset network connection devices, step S122 of FIG. 2 may be implemented as steps S51-S52 as shown in FIG. 5.

In step S51, determining a network address of the preset network connection device corresponding to the identity of the terminal based on the correspondence between terminals and preset network connection devices.

In step S52, searching the preset network connection device corresponding to the terminal according to the network address.

In the embodiment, the network address may be a Media Access Control (MAC) address, or may be an Internet Protocol (IP) address. For example, when the network address is the MAC address, because each network connection device has a unique MAC address, an unique network connection device corresponding to the identity of the terminal (i.e., the preset network connection device corresponding to the terminal) can be found according to the correspondence between identities of terminals and MAC addresses of candidate preset network connection devices. It can be seen that, using the technical solution in the embodiment, the determination of the preset network connection device becomes more accurate, and the situation where other network connection devices have the same network name as that of the preset network connection device for the terminal can be avoided. Thus, the network side (e.g., the computer server) can accurately determine whether the terminal is in the proximity of the preset network connection device corresponding to the terminal, and if the terminal is in the proximity of the preset network connection device corresponding to the terminal, the network side can timely notify the user so that the terminal can access the preset network connection device corresponding to the terminal. Consequently, user experience when using networks is improved.

In an embodiment, after determining the preset network connection device according to the above method, matching between the first network information and the second network information corresponding to the preset network connection device can be performed. Thus, the above step S12 of FIG. 1 may be implemented as the following steps: determining whether network identities in the second network information contain a network identity in the first network information; and if the network identities in the second network information contain the network identity in the first network information, determining that the first network information matches the pre-stored second network information. The network identities may the network names, or may be network addresses, for example, MAC addresses or IP addresses. When the network identities in the second network information contain the network identity in the first network information, the computer server in the network side may determine that the network connection device to which the terminal is currently connected happens to be one network connection device in the proximity of the preset network connection device, and that the terminal is currently in the proximity of the preset network connection device.

In an embodiment, the above step S13 of FIG. 1 may be implemented as the following steps: determining whether a network signal strength of the preset network connection device is greater than a network signal strength of the network connection device which the terminal is currently connected to; and if the network signal strength of the preset network connection device is greater than the network signal strength of the network connection device which the terminal is currently connected to, sending a notification to the terminal. In the embodiment, the network side sends the notification information to the terminal only if the network signal strength of the preset network connection device is greater than the network signal strength of the network connection device which the terminal is currently connected to. The embodiment can avoid the situation where the terminal accesses a preset network connection device having a weak network signal strength, and thus can guarantee the signal strength of the network connections established by the terminal. Consequently, user experience when using networks is improved. Further, a signal strength threshold may be set in advanced. The lowest standard of the signal strength threshold is a signal strength value allowing the terminal to perform normal network communications. When the network side determines that the terminal is in the proximity of the preset network connection device, the terminal may firstly determine whether the signal strength of the preset network connection device meets the preset signal strength threshold; when the signal strength of the preset network connection device meets the preset signal strength threshold, the network side may send the notification to the terminal, notifying the terminal that the terminal can access the preset network connection device corresponding to the terminal; otherwise, the network side does not send the notification information. The signal strength at the terminal for the preset network connection device and network connection device that the terminal is currently may be measured by the terminal and then communicated to the network side for determining whether to send the notification information.

In an embodiment, the above methods may further include: sending the terminal a third network information of the preset network connection device, wherein the third network information may include one or more of a network name and a network password of the preset network connection device. In the embodiment, because the network information of the preset network connection device may be modified by the user at any time, the network information of the preset network connection device pre-stored in the terminal may be out of date. Thus, the network information of the preset network connection device stored at the network side is more accurate as compared with the network information pre-stored in the terminal. Thus, the network (e.g., the computer server) may send the terminal the network information of the preset network connection devices to guarantee that the terminal can accurately access the preset network connection device by the network information. Thus, the network connection of the terminal is ensured and thereby user experience is improved.

In the technical solution provided by embodiments of the present disclosure, matching between network information of a network connection device which a terminal is currently connected to and network information of a network connection device within a preset range of a preset network connection device corresponding to the terminal is performed. Thus, if the terminal is in the proximity of the preset network connection device corresponding to the terminal, the network side can timely notify the terminal so that the terminal can access the preset network connection device corresponding to the terminal. Consequently, user experience when using networks is improved, and especially, the speed for accessing data in the preset network connection device is increased.

Terminal Side

FIG. 6 is a flowchart showing a method for network connection according to an exemplary embodiment. The method may be implemented in a terminal as shown in FIG. 26. For example, the terminal may be a mobile phone, a computer, a digital broadcast terminal, a messaging device, a gaming console, a tablet, a medical device, exercise equipment, a personal digital assistant, and the like. The method may include the following steps S61-S63.

In step S61, sending the first network information of a network connection device which the terminal is currently connected to a network side.

In step S62, if the terminal receives first notification information from the network side, obtaining the third network information of a preset network connection device corresponding to the terminal. The first notification information is configured to notify the terminal that the terminal can be connected to the preset network connection device, and the third network information includes one or more of a network name and a network password of the preset network connection device.

In the step, the terminal may obtain the third network information via the following two approaches: (1) obtaining the third network information of the preset network connection device corresponding to the terminal which is pre-stored in the terminal; or (2) obtaining the third network information of the preset network connection device corresponding to the terminal from the network side.

In step S63, connecting to the preset network connection device according to the third network information.

In an embodiment, step S62 may be implemented as the following steps: sending a second notification information for inquiring whether to access the preset network connection device; and if receiving a confirmation operation for the second notification information, accessing the preset network connection device according to the third network information. In the embodiment, whether to connect to the preset network connection device is determined according to user's selection. User engagement is increased and thus user experience during network communications by the terminal is improved.

In the technical solution provided by embodiments of the present disclosure, when obtaining the notification information sent from the network side, the terminal can access the preset network connection device corresponding to the terminal. Thus, when the terminal is in the proximity of the preset network connection device corresponding to the terminal, the terminal can timely access the preset network connection device. In this way, the technical solution can improve the states of network connection of the terminal, and can avoid the situation where when the terminal is in the proximity of the preset network connection device, the terminal uses external network connection. Consequently, user experience when using networks is improved, and especially the speed for accessing data in the preset network connection device by the terminal is increased.

Preset Network Connection Device Side

FIG. 7 is a flowchart showing a method for network connection according to an exemplary embodiment. The method for network connection may be implemented in a preset network connection device such as a preset router. The method may include the following steps S71-S72.

In step S71, obtaining network information of other network connection devices within a preset range.

In the step, the preset network connection device may periodically obtain the network information of other network connection devices within a preset range. For example, the preset network connection device can obtain the network information of the network connection devices within the preset range at one or more fixed time every day in order to follow up any changes about its surrounding network connection devices.

In step S72, sending the network information to a network side (i.e., a computer server and/or a cloud server connected to the network connection device through a network).

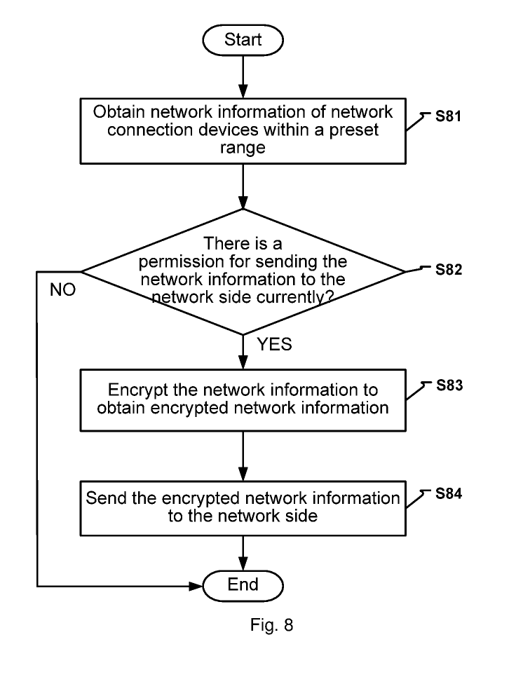

In an embodiment, when the preset network connection device sends the network information to the network side, the preset network connection device needs to determine whether it has the sending permission. The preset network connection device sends the network information to the network side only if the preset network connection device is authorized to do so to increase the security level of the network information of the network connection device. Further, the network information may be encrypted, and the encrypted network information can be sent to the network side. This can also increase the security level of the network information of the network connection device. As shown in FIG. 8, the above method may be implemented as the following steps S81-S84.

In step S81, obtaining network information of network connection devices within the preset range of the preset network device.

In step S82, determining whether the preset network connection device currently has a permission to send the network information of the network devices within the preset range of the preset network device to the network side. If it is determined that the preset network connection device has the permission, performing step S83. If it is determined that the preset network connection device does not have the permission for currently sending the network information to the network side, the flowchart ends.

In step S83, the network information is encrypted to obtain encrypted network information.

In step S84, the encrypted network information is sent to the network side.

In the technical solution provided by embodiments of the present disclosure, under the operation of the network connection device, the network information of network connection devices within a preset range is obtained, and the network information is sent to a network side, so that the network side can determine whether a terminal corresponding to a preset network connection device is in the proximity of the preset network connection device according to the received network information. If the terminal corresponding to the preset network connection device is in the proximity of the preset network connection device, the network side can timely notify the terminal to make the terminal access the preset network connection device corresponding to the terminal. Thus, user experience when using networks is improved, and especially the speed for accessing data in the preset network connection device by the terminal is increased.

The method for network connection provided by the present disclosure will be explained using a specific example.

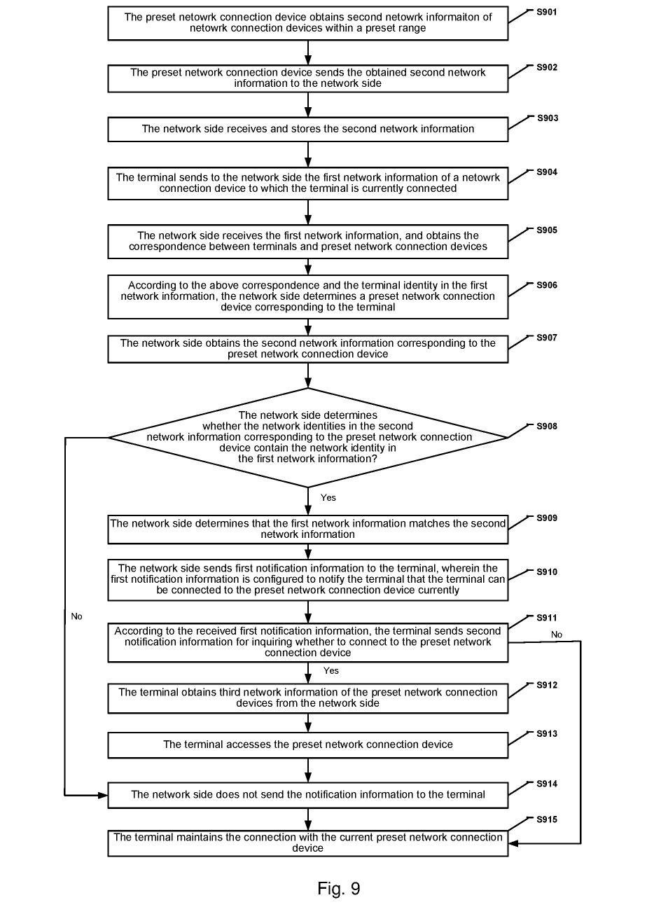

FIG. 9 is a flowchart showing a method for network connection according to a specific exemplary embodiment. In the embodiment, the method for network connection involves three parties, i.e., a network side server, such as one or more computer servers and/or cloud servers; a terminal; and a preset network connection device such as a preset router. In the database at the network side, a correspondence between terminals and preset network connection devices are pre-stored. As shown in FIG. 9, the method for network connection includes the following steps S901-S915.

In step S901, the preset network connection device obtains second network information of network connection devices within a preset range.

In step S902, the preset network connection device sends the obtained second network information to the network side. The second network information includes network identities which are network names or network addresses.

In step S903, the network side receives and stores the second network information.

In step S904, the terminal sends to the network side the first network information of a network connection device to which the terminal is currently connected. The first network information includes a terminal identity, and a network identity which is a network name or a network address.

In step S905, the network side receives the first network information, and obtains the correspondence between terminals and preset network connection devices.

In step S906, according to the above correspondence and the terminal identity in the first network information, the network side determines a preset network connection device corresponding to the terminal.

In step S907, the network side obtains the second network information corresponding to the preset network connection device.

In step S908, the network side determines whether the network identities in the second network information corresponding to the preset network connection device contain the network identity in the first network information. If the network identities in the second network information corresponding to the preset network connection device contain the network identity in the first network information, step S909 is performed. If the network identities in the second network information corresponding to the preset network connection device do not contain the network identity in the first network information, step S914 is performed.

In step S909, the network side determines that the first network information matches the second network information.

In step S910, the network side sends first notification information to the terminal. The first notification information is configured to notify the terminal that the terminal can be connected to the preset network connection device currently.

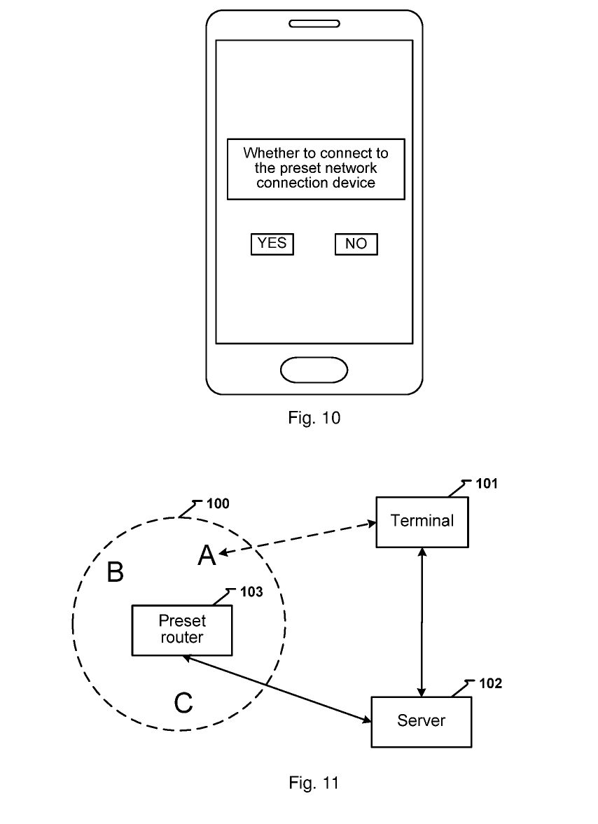

In step S911, according to the received first notification information, the terminal sends second notification information for inquiring whether to connect to the preset network connection device. As shown in FIG. 10, the terminal displays the second notification “Whether to connect to the preset network connection device” on a current screen, and displays “YES” and “NO” options for the second notification information. When receiving a selection operation by the user for the “YES” option, step S912 is performed; when receiving the selection operation by the user for the “NO” option, step S915 is performed.

In step S912, the terminal obtains the third network information of the preset network connection devices from the network side. The third network information includes the network names and network passwords of the preset network connection devices.

In step S913, the terminal accesses the preset network connection device.

In step S914, the network side does not send the notification information to the terminal.

In step S915, the terminal maintains the connection with the current preset network connection device.

For example, a preset network connection device corresponding to a terminal 101 is a preset router 103, and the terminal 101 is connected to a network connection device A. The preset router 103 periodically detects and obtains network information of network connection devices within a preset range, for example, within 20 meters. As shown in FIG. 11, the region circled by a dotted-line 100 represents the region within the preset range of the preset router 103. The preset router 103 can detect that there are the network connection device A, and network connection devices B and C within the preset range, and obtain the network information (including the network names) of the network connection devices A, B and C, and send the obtained network information to a server 102 at the network side. After receiving from the terminal 101 the network information (including the network name) of the device A to which the terminal 101 is currently connected, the server 102 matches the network information of the device A with the network information of the network connection devices A, B and C sent from the preset router 103. By comparing the network names in the network information, the server 102 determines that the network information of the network connection devices A, B and C sent from the preset router 103 includes the network information of the device A, and thereby determines that the terminal 101 is in the vicinity of the preset router 103, and sends the terminal 101 the notification information for notifying the terminal 101 that the terminal 101 can access the preset router 103 currently.

In the technical solution provided by the present embodiment, when a terminal is in the proximity of a router corresponding to the terminal, a server can timely notify the terminal so that the terminal can access the router corresponding to the terminal. Then, the terminal can access the data in the router via internal networks. As compared with the network connections via other network connection devices, accessing of data via the preset network device and internal network is relatively fast and thus user experience when using networks is improved.

Embodiments of devices of the present disclosure, which may be used for performing the embodiments of the methods of the present disclosure, will be described below.

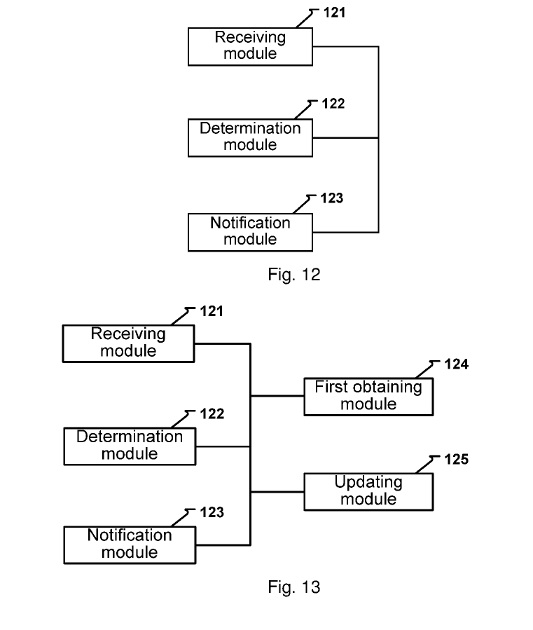

FIG. 12 is a block diagram showing an apparatus for network connection according to an exemplary embodiment. The apparatus may be implemented as a part or whole of an electronic device with software, hardware or the both. Referring to FIG. 12, the apparatus for network connection is applied at a network side and includes a receiving module 121, a determination module 122 and a notification module 123.

The receiving module 121 is configured to receive first network information of a network connection device which a terminal is currently connected to.

The determination module 122 is configured to determine whether the first network information matches pre-stored second network information which is network information of a network connection device within a preset range of a preset network connection device corresponding to the terminal.

The notification module 123 is configured to, if the first network information matches the second network information, send the terminal notification information for notifying the terminal that the terminal can be connected to the preset network connection device currently.

In an embodiment, as shown in FIG. 13, the device further includes a first obtaining module 124 and an updating module 125.

The first obtaining module 124 is configured to periodically obtain the second network information sent from the preset network connection device.

The updating module 125 is configured to update the second network information.

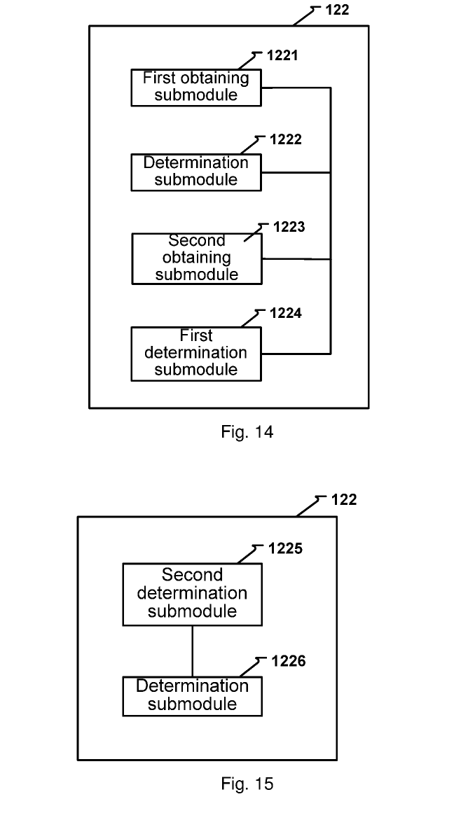

In an embodiment, as shown in FIG. 14, the determination module 122 includes a first obtaining submodule 1221, a determination submodule 1222, a second obtaining submodule 1223 and a first determination submodule 1224.

The first obtaining submodule 1221 is configured to obtain a correspondence between terminals and preset network connection devices.

The determination submodule 1222 is configured to determine the preset network connection device corresponding to the terminal according to the correspondence.

The second obtaining submodule 1223 is configured to obtain the second network information corresponding to the preset network connection device.

The first determination submodule 1224 is configured to determine whether the first network information matches the pre-stored second network information corresponding to the preset network connection device.

In an embodiment, the determination submodule 1222 is configured to, if the correspondence is a correspondence between identities of terminals and network names of preset network connection devices and the information sent from the terminal include an identity of the terminal in addition to the first network information, determine a network name corresponding to the identity of the terminal according to the correspondence, and search a network connection device having the network name, and determine the network connection device having the network name as the preset network connection device.

In an embodiment, the determination submodule 1222 is further configured to, if there are at least two network connection devices have the network name, determine matching degrees between the at least two network connection devices and the terminal, and according to the matching degrees, determine the preset network device corresponding to the terminal among the at least two network connection devices.

In an embodiment, the determination submodule 1222 is further configured to obtain historical records of network connections performed by the terminal via the at least two network connection devices, and according to the historical records, determine connection parameters of the network connections performed by the terminal via the at least two network connection devices, wherein the connection parameters include at least one of number of times of connection, connection frequency, and connection speed, and according to the connection parameters, determine the matching degrees between the at least two network connection devices and the terminal.

In an embodiment, the determination submodule 1222 is configured to, if the correspondence is a correspondence between identities of terminals and network addresses of preset network connection devices and the information sent from the terminal include an identity of the terminal in addition to the first network information, determine a network address corresponding to the identity of the terminal according to the correspondence, and search the preset network connection device corresponding to the terminal according to the network address.

In an embodiment, as shown in FIG. 15, the determination module 122 includes a second determination submodule 1225 and a determination submodule 1226.

The second determination submodule 1225 is configured to determine whether network identities in the second network information contain a network identity in the first network information, wherein the first network information and the second network information include network identities which are network names or network addresses.

The determination submodule 1226 is configured to, if the network identities in the second network information contain the network identity in the first network information, determine that the first network information matches the pre-stored second network information.

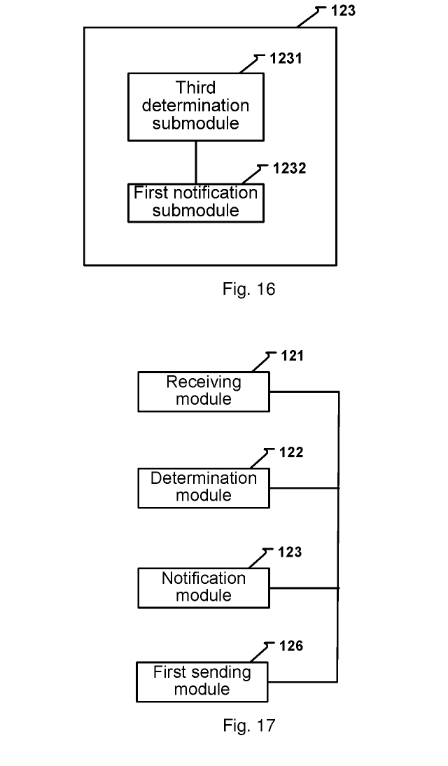

In an embodiment, as shown in FIG. 16, the notification module 123 includes a third determination submodule 1231 and a first notification submodule 1232.

The third determination submodule 1231 is configured to determine whether a network signal strength of the preset network connection device is greater than a network signal strength of the network connection device which the terminal is currently connected to.

The first notification submodule 1232 is configured to, if the network signal strength of the preset network connection device is greater than the network signal strength of the network connection device which the terminal is currently connected to, send the terminal the notification information.

In an embodiment, as shown in FIG. 17, the device further includes a first sending module 126.

The first sending module 126 is configured to send the terminal a third network information of the preset network connection device which includes at least one of a network name and a network password of the preset network connection device.

In the devices provided by embodiments of the present disclosure, matching between network information of a network connection device which a terminal is currently connected to and network information of a network connection device within a preset range of a preset network connection device corresponding to the terminal is performed. Thus, if the terminal is in the proximity of the preset network connection device corresponding to the terminal, the network side can timely notify the terminal so that the terminal can access the preset network connection device corresponding to the terminal. Consequently, user experience when using networks is improved, and especially, the speed for accessing data in the preset network connection device is increased.

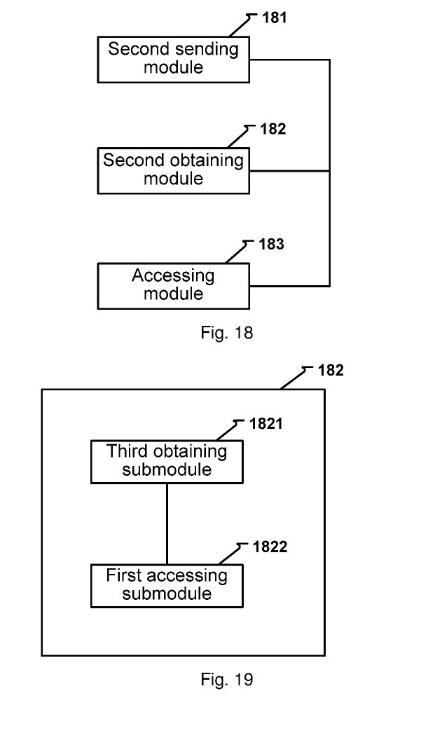

FIG. 18 is a block diagram showing an apparatus for network connection according to an exemplary embodiment. The apparatus may be implemented as a part or whole of an electronic device with software, hardware or the both. Referring to FIG. 18, the apparatus for network connection is applied in a terminal, and includes a second sending module 181, a second obtaining module 182 and an accessing module 183.

The second sending module 181 is configured to send a network side first network information of a network connection device which the terminal is currently connected to.

The second obtaining module 182 is configured to, if first notification information sent from the network side is received, obtain the third network information of a preset network connection device corresponding to the terminal, wherein the first notification information is configured to notify the terminal that the terminal can be connected to the preset network connection device, and the third network information includes at least one of a network name and a network password of the preset network connection device.

The accessing module 183 is configured to access the preset network connection device according to the third network information.

In an embodiment, as shown in FIG. 19, the second obtaining module 182 includes a third obtaining submodule 1821 or a first accessing submodule 1822.

The third obtaining submodule 1821 is configured to obtain pre-stored third network information of the preset network connection device corresponding to the terminal.

The first accessing submodule 1822 is configured to obtain the third network information of the preset network connection device corresponding to the terminal from the network side.

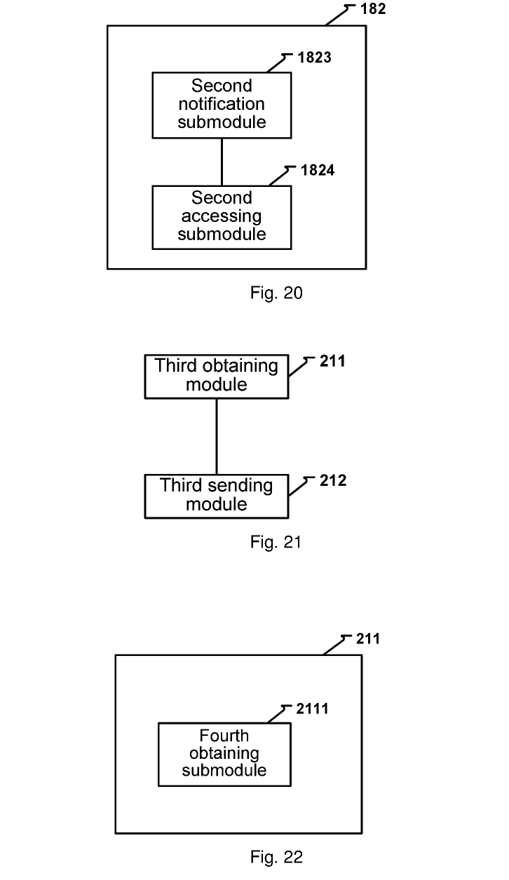

In an embodiment, as shown in FIG. 20, the second obtaining module 182 includes a second notification submodule 1823 and a second accessing submodule 1824.

The second notification submodule 1823 is configured to send second notification information for inquiring whether to access the preset network connection device.

The second accessing submodule 1824 is configured to, if a confirmation operation for the second notification information is received, access the preset network connection device according to the third network information.

In the device provided by embodiments of the present disclosure, when obtaining the notification information sent from the network side, the terminal can access the preset network connection device corresponding to the terminal. Thus, when the terminal is in the proximity of the preset network connection device corresponding to the terminal, the terminal can timely access the preset network connection device. In this way, the technical solutions can improve the states of network connection of the terminal, and can avoid the situation where when the terminal is in the proximity of the preset network connection device, the terminal uses external network connection. Consequently, user experience when using networks is improved, and especially the speed for accessing data in the preset network connection device by the terminal is increased.

FIG. 21 is a block diagram showing an apparatus for network connection according to an exemplary embodiment. The apparatus may be implemented as a part or whole of an electronic device with software, hardware or the both. Reference to FIG. 21, the apparatus for network connection may be applied in a preset network connection device, and includes a third obtaining module 211 and a third sending module 212.

The third obtaining module 211 is configured to obtain network information of network connection devices within a preset range.

The third sending module 212 is configured to send the network information to a network side.

In an embodiment, as shown in FIG. 22, the third obtaining module 211 includes a fourth obtaining submodule 2111.

The fourth obtaining submodule 2111 is configured to periodically obtain the network information of network connection devices within the preset range.

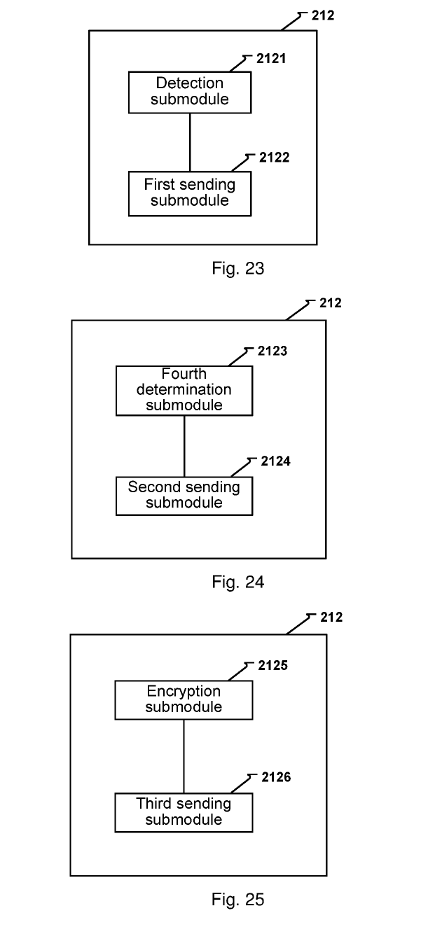

In an embodiment, as shown in FIG. 23, the third sending module 212 includes a detection submodule 2121 and a first sending submodule 2122.

The detection submodule 2121 is configured to detect whether the network connection devices within the preset range change.

The first sending submodule 2122 is configured to, if it is detected that the network connection devices within the preset range change, send the network information to the network side.

In an embodiment, as shown in FIG. 24, the third sending module 212 includes a fourth determination submodule 2123 and a second sending submodule 2124.

The fourth determination submodule 2123 is configured to determine whether there is permission for sending the network information to the network side currently.

The second sending submodule 2124 is configured to, if it is determined that there is the permission, send the network information to the network side.

In an embodiment, as shown in FIG. 25, the third sending module 212 includes an encryption submodule 2125 and a third sending submodule 2126.

The encryption submodule 2125 is configured to encrypt the network information to obtain encrypted network information.

The third sending submodule 2126 is configured to send the encrypted network information to the network side.

In the device provided by embodiments of the present disclosure, network information of network connection devices within a preset range is obtained, and the network information is sent to a network side, so that the network side can determine whether a terminal corresponding to a preset network connection device is in the proximity of the preset network connection device according to the received network information. If the terminal corresponding to the preset network connection device is in the proximity of the preset network connection device, the network side can timely notify the terminal to make the terminal access the preset network connection device corresponding to the terminal. Thus, user experience when using networks is improved, and especially the speed for accessing data in the preset network connection device by the terminal is increased.

In an exemplary embodiment, there is provided an apparatus for network connection, applied at a network side and including:

a processor; and

a memory for storing instructions executable by the processor;

wherein the processor is configured to:

receive first network information of a network connection device which a terminal is currently connected to;

determine whether the first network information matches pre-stored second network information which is network information of a network connection device within a preset range of a preset network connection device corresponding to the terminal; and

if the first network information matches the second network information, send the terminal notification information for notifying the terminal that the terminal can be connected to the preset network connection device currently.

The processor is further configured to:

periodically obtain the second network information sent from the preset network connection device; and

update the second network information.

The processor is configured to:

obtain a correspondence between terminals and preset network connection devices;

determine the preset network connection device corresponding to the terminal according to the correspondence;

obtain the second network information corresponding to the preset network connection device; and

determine whether the first network information matches the pre-stored second network information corresponding to the preset network connection device.

The processor is configured to:

If the correspondence is a correspondence between identities of terminals and network names of preset network connection devices and information sent from the terminal include an identity of the terminal in addition to the the first network information i, determine a network name corresponding to the identity of the terminal according to the correspondence; and

search a network connection device having the network name, and determine the network connection device having the network name as the preset network connection device.

The processor is configured to:

if there are at least two network connection devices have the network name, determine matching degrees between the at least two network connection devices and the terminal; and

according to the matching degrees, determine the preset network device corresponding to the terminal among the at least two network connection devices.

The processor is configured to:

obtain historical records of network connections performed by the terminal via the at least two network connection devices;

according to the historical records, determine connection parameters of the network connections performed by the terminal via the at least two network connection devices, wherein the connection parameters include at least one of number of times of connection, connection frequency, and connection speed; and

according to the connection parameters, determine the matching degrees between the at least two network connection devices and the terminal.

The processor is configured to:

if the correspondence is a correspondence between identities of terminals and network addresses of preset network connection devices and the information sent from the terminal include an identity of the terminal in addition to the first network information, determine a network address corresponding to the identity of the terminal according to the correspondence; and

search the preset network connection device corresponding to the terminal according to the network address.

The processor is configured to:

if the first network information and the second network information include network identities which are network names or network addresses, determine whether network identities in the second network information contain a network identity in the first network information; and

if the network identities in the second network information contain the network identity in the first network information, determine that the first network information matches the pre-stored second network information.

The processor is configured to:

determine whether a network signal strength of the preset network connection device is greater than a network signal strength of the network connection device which the terminal is currently connected to; and

if the network signal strength of the preset network connection device is greater than the network signal strength of the network connection device which the terminal is currently connected to, send the terminal the notification information.

The processor is further configured to:

send the terminal third network information of the preset network connection device which includes at least one of a network name and a network password of the preset network connection device.

In an exemplary embodiment, there is provided an apparatus for network connection, applied in a terminal and including:

a processor; and

a memory for storing instructions executable by the processor;

wherein the processor is configured to:

send a network side first network information of a network connection device which the terminal is currently connected to;

if receive first notification information sent from the network side, obtain third network information of a preset network connection device corresponding to the terminal, wherein the first notification information is configured to notify the terminal that the terminal can be connected to the preset network connection device, and the third network information includes at least one of a network name and a network password of the preset network connection device; and

access the preset network connection device according to the third network information.

The processor is configured to:

obtain pre-stored third network information of the preset network connection device corresponding to the terminal; or

obtain the third network information of the preset network connection device corresponding to the terminal from the network side.

The processor is configured to:

send second notification information for inquiring whether to access the preset network connection device; and

if a confirmation operation for the second notification information is received, access the preset network connection device according to the third network information.

In an exemplary embodiment, there is provided an apparatus for network connection, applied in a preset network connection device and including:

a processor; and

a memory for storing instructions executable by the processor;

wherein the processor is configured to:

obtain network information of network connection devices within a preset range; and

send the network information to a network side.

The processor is configured to:

periodically obtain the network information of network connection devices within the preset range.

The processor is configured to:

detect whether the network connection devices within the preset range change; and

if it is detected that the network connection devices within the preset range change, send the network information to the network side.

The processor is configured to:

determine whether there is a permission for sending the network information to the network side currently; and

if it is determined that there is the permission, send the network information to the network side.

The processor is configured to:

encrypt the network information to obtain encrypted network information; and

send the encrypted network information to the network side.

With respect to the devices in the above embodiments, the specific manners for performing operations for individual modules therein have been described in detail in the embodiments regarding the methods, which will not be elaborated herein.

According to another exemplary embodiment of the present disclosure as shown in FIG. 26, the device 2600 includes a non-transitory computer-readable storage medium having stored therein instructions that, when executed by the processor of the apparatus 2600, causes the apparatus 2600 to perform the method for network connection, the method including:

sending a network side first network information of a network connection device which the terminal is currently connected to;

if receiving first notification information sent from the network side, obtaining third network information of a preset network connection device corresponding to the terminal, wherein the first notification information is configured to notify the terminal that the terminal can be connected to the preset network connection device, and the third network information includes at least one of a network name and a network password of the preset network connection device; and

accessing the preset network connection device according to the third network information.

The obtaining the third network information of the preset network connection device corresponding to the terminal, includes:

obtaining pre-stored thrir network information of the preset network connection device corresponding to the terminal; or

obtaining the third network information of the preset network connection device corresponding to the terminal from the network side.

The obtaining the third network information of the preset network connection device corresponding to the terminal, includes:

sending second notification information for inquiring whether to access the preset network connection device; and

if receiving a confirmation operation for the second notification information, accessing the preset network connection device according to the third network information.

There is provided a non-transitory computer-readable storage medium having stored therein instructions that, when executed by the processor of the apparatus 2600, causes the apparatus 2600 to perform the method for network connection, the method including:

obtaining network information of network connection devices within a preset range;

and

sending the network information to a network side.

the obtaining the network information of the network connection devices within the preset range, includes:

periodically obtaining the network information of network connection devices within the preset range.

the sending the network information to the network side, includes:

detecting whether the network connection devices within the preset range change; and

if detecting that the network connection devices within the preset range change, sending the network information to the network side.

The sending the network information to the network side, includes:

determining whether there is a permission for sending the network information to the network side currently; and

if determining that there is the permission, sending the network information to the network side.

The sending the network information to the network side, includes:

encrypting the network information to obtain encrypted network information; and

sending the encrypted network information to the network side.

According to another exemplary embodiment of the present application, as shown in FIG. 27, the device 1900 may include a non-transitory computer-readable storage medium having stored therein instructions that, when executed by a processor of the apparatus 1900, causes the apparatus 1900 to perform a method for network connection, the method including

receiving first network information of a network connection device which a terminal is currently connected to;

determining whether the first network information matches pre-stored second network information which is network information of a network connection device within a preset range of a preset network connection device corresponding to the terminal; and

if the first network information matches the second network information, sending the terminal notification information for notifying the terminal that the terminal can be connected to the preset network connection device currently.

The method further includes:

periodically obtaining the second network information sent from the preset network connection device; and

updating the second network information.

The determining whether the first network information matches the pre-stored second network information, includes:

obtaining a correspondence between terminals and preset network connection devices;

determining the preset network connection device corresponding to the terminal according to the correspondence;

obtaining the second network information corresponding to the preset network connection device; and

determining whether the first network information matches the pre-stored second network information corresponding to the preset network connection device.

The correspondence is a correspondence between identities of terminals and network names of preset network connection devices, and the information sent from the terminal include an identity of the terminal in addition to the first network information. The determining the preset network connection device corresponding to the terminal according to the correspondence, includes:

determining a network name corresponding to the identity of the terminal according to the correspondence; and

searching a network connection device having the network name, and determining the network connection device having the network name as the preset network connection device.

If there are at least two network connection devices have the network name, the determining the preset network connection device corresponding to the terminal according to the correspondence, further includes:

determining matching degrees between the at least two network connection devices and the terminal; and

according to the matching degrees, determining the preset network device corresponding to the terminal among the at least two network connection devices.

The determining matching degrees between the at least two network connection devices and the terminal, includes:

obtaining historical records of network connections performed by the terminal via the at least two network connection devices;

according to the historical records, determining connection parameters of the network connections performed by the terminal via the at least two network connection devices, wherein the connection parameters include at least one of number of times of connection, connection frequency, and connection speed; and

according to the connection parameters, determining the matching degrees between the at least two network connection devices and the terminal.

The correspondence is a correspondence between identities of terminals and network addresses of preset network connection devices, and information sent from the terminal include an identity of the terminal in addition to the the first network information. The determining the preset network connection device corresponding to the terminal according to the correspondence, includes:

determining a network address corresponding to the identity of the terminal according to the correspondence; and

searching the preset network connection device corresponding to the terminal according to the network address.

The first network information and the second network information include network identities which are network names or network addresses. The determining whether the first network information matches the pre-stored second network information includes:

determining whether network identities in the second network information contain a network identity in the first network information; and

if the network identities in the second network information contain the network identity in the first network information, determining that the first network information matches the pre-stored second network information.

The sending the terminal the notification information includes:

determining whether a network signal strength of the preset network connection device is greater than a network signal strength of the network connection device which the terminal is currently connected to; and

if the network signal strength of the preset network connection device is greater than the network signal strength of the network connection device which the terminal is currently connected to, sending the terminal the notification information.

The method further includes:

sending the terminal third network information of the preset network connection device which includes at least one of a network name and a network password of the preset network connection device.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for network connection, applied at a network side, the method comprising:
receiving a first network information of a network connection device to which a terminal is currently connected;
determining whether the first network information matches a pre-stored second network information, wherein the pre-stored second network information corresponds to at least one network connection device within a preset range of a preset network connection device corresponding to the terminal;
determining whether the first network information matches the second network information; and
sending to the terminal a notification information for notifying the terminal that the terminal can be connected to the preset network connection device upon determining that the first network information matches the second network information.

2. The method according to claim 1, wherein determining whether the first network information matches the pre-stored second network information comprises:
obtaining a correspondence between one or more terminals and one or more preset network connection devices;
determining the preset network connection device corresponding to the terminal according to the correspondence;
obtaining the second network information corresponding to the preset network connection device; and
determining whether the first network information matches the pre-stored second network information corresponding to the preset network connection device.

3. The method according to claim 2, further comprising receiving an identity of the terminal,
wherein the correspondence is a correspondence between identities of the one or more terminals and network names of the one or more preset network connection devices; and
wherein determining the preset network connection device corresponding to the terminal according to the correspondence, comprises:
determining a network name corresponding to the identity of the terminal according to the correspondence; and
searching a network connection device having the network name, and determining the network connection device having the network name as the preset network connection device.

4. The method according to claim 3, wherein, if there are at least two network connection devices having the network name, determining the preset network connection device corresponding to the terminal according to the correspondence further comprises:
determining matching degrees between the at least two network connection devices and the terminal; and
according to the matching degrees, determining the preset network device corresponding to the terminal among the at least two network connection devices.

5. The method according to claim 4, wherein determining matching degrees between the at least two network connection devices and the terminal comprises:
obtaining historical records of network connections between the terminal and each of the at least two network connection devices;
according to the historical records, determining connection parameters of the network connections between the terminal and each of the at least two network connection devices, wherein the connection parameters comprise at least one of number of times of connection, connection frequency, and connection speed; and
according to the connection parameters, determining the matching degrees between the at least two network connection devices and the terminal.

6. The method according to claim 2, further comprising receiving an identity of the terminal,
wherein the correspondence is a correspondence between identities of one or more terminals and network addresses of one or more preset network connection devices; and
wherein determining the preset network connection device corresponding to the terminal according to the correspondence comprises:
determining a network address corresponding to the identity of the terminal according to the correspondence; and
searching the preset network connection device corresponding to the terminal according to the network address.

7. The method according to claim 1, wherein the first network information and the second network information comprise network identities comprising network names or network addresses;
wherein determining whether the first network information matches the pre-stored second network information comprises:
determining whether network identities in the second network information contain a network identity in the first network information; and
if the network identities in the second network information contain the network identity in the first network information, determining that the first network information matches the pre-stored second network information.

8. The method according to claim 1, wherein sending to the terminal the notification information comprises:
determining whether a network signal strength of the preset network connection device is greater than a network signal strength of the network connection device to which the terminal is currently connected; and
if the network signal strength of the preset network connection device is greater than the network signal strength of the network connection device to which the terminal is currently connected, sending to the terminal the notification information.

9. The method according to claim 1, further comprising:
sending to the terminal a third network information of the preset network connection device, where in the third network information comprises at least one of a network name and a network password of the preset network connection device.

10. A method for network connection, applied in a terminal associated with a preset network connection device, the method comprising:
sending to a network side a first network information of a network connection device to which the terminal is currently connected;
in response to receiving a first notification information sent from the network side, obtaining a third network information for the preset network connection device corresponding to the terminal, wherein the first notification information is configured to notify the terminal that the terminal can be connected to the preset network connection device, and the third network information comprises at least one of a network name and a network password of the preset network connection device; and
accessing the preset network connection device according to the other network information.

11. The method according to claim 10, wherein the obtaining the third network information of the preset network connection device corresponding to the terminal comprises:
obtaining the third network information pre-stored in the terminal; or
obtaining the third network information of the preset network connection device corresponding to the terminal from the network side.

12. An apparatus for network connection, applied at a network side, the apparatus comprising:
a processor; and
a memory for storing instructions executable by the processor;
wherein the processor is configured to:
receive a first network information of a network connection device to which a terminal is currently connected;
determine whether the first network information matches a pre-stored second network information, wherein the pre-stored second network information corresponds to at least one network connection device within a preset range of a preset network connection device corresponding to the terminal;
determine whether the first network information matches the second network information; and
send to the terminal a notification information for notifying the terminal that the terminal can be connected to the preset network connection device upon determining that the first network information matches the second network information.

13. The apparatus according to claim 12, wherein, to determine whether the first network information matches the pre-stored second network information, the processor is configured to:
obtain a correspondence between one or more terminals and one or more preset network connection devices;
determine the preset network connection device corresponding to the terminal according to the correspondence;
obtain the second network information corresponding to the preset network connection device; and
determine whether the first network information matches the pre-stored second network information corresponding to the preset network connection device.

14. The apparatus according to claim 13,
wherein the processor is further configured to receive an identity of the terminal;
wherein the correspondence is a correspondence between identities of the one or more terminals and network names of one or more preset network connection devices; and
wherein, to determine the preset network connection device corresponding to the terminal according to the correspondence, the processor is configured to:
determine a network name corresponding to the identity of the terminal according to the correspondence; and
search a network connection device having the network name, and determining the network connection device having the network name as the preset network connection device.

15. The apparatus according to claim 14, wherein, if there are at least two network connection devices having the network name, to determine the preset network connection device corresponding to the terminal according to the correspondence, the processor is further configured to:
determine matching degrees between the at least two network connection devices and the terminal; and
according to the matching degrees, determine the preset network device corresponding to the terminal among the at least two network connection devices.

16. The apparatus according to claim 15, wherein, to determine matching degrees between the at least two network connection devices and the terminal, the processor is configured to:
obtain historical records of network connections between the terminal and each of the at least two network connection devices;
according to the historical records, determine connection parameters of the network connections between the terminal and each of the at least two network connection devices, wherein the connection parameters comprise at least one of number of times of connection, connection frequency, and connection speed; and
according to the connection parameters, determine the matching degrees between the at least two network connection devices and the terminal.

17. The apparatus according to claim 13,
wherein the processor is further configured to receive an identity of the terminal;
wherein the correspondence is a correspondence between identities of one or more terminals and network addresses of one or more preset network connection devices; and
wherein, to determine the preset network connection device corresponding to the terminal according to the correspondence, the processor is configured to:
determine a network address corresponding to the identity of the terminal according to the correspondence; and
search the preset network connection device corresponding to the terminal according to the network address.

18. The apparatus according to claim 12, wherein the first network information and the second network information comprise network identities comprising network names or network addresses;
Wherein, to determine whether the first network information matches the pre-stored second network information, the processor is configured to:
determine whether network identities in the second network information contain a network identity in the first network information; and
if the network identities in the second network information contain the network identity in the first network information, determine/that the first network information matches the pre-stored second network information.

19. The apparatus according to claim 12, wherein, to send to the terminal the notification information, the processor is configured to:
determine whether a network signal strength of the preset network connection device is greater than a network signal strength of the network connection device to which the terminal is currently connected; and
if the network signal strength of the preset network connection device is greater than the network signal strength of the network connection device to which the terminal is currently connected, send to the terminal the notification information.

20. A terminal apparatus for network connection, comprising:
a processor; and
a memory for storing instructions executable by the processor;
wherein the processor is configured to:
send to a network side a first network information of a network connection device to which the terminal is currently connected;
in response to receiving a first notification information sent from the network side, obtain a third network information for a preset network connection device corresponding to the terminal, wherein the first notification information is configured to notify the terminal that the terminal can be connected to the preset network connection device, and the third network information comprises at least one of a network name and a network password of the preset network connection device; and
access the preset network connection device according to the third network information.
